(19) United States
(12) Patent Application Publication
(10) Pub. No.: US 2006/0160384 A1
(43) Pub. Date: Jul. 20, 2006

(54) Plug and cord protection device

(76) Inventor: Karen M. Brazina, Chandler, OK (US)

Correspondence Address: THE INVENTORS NETWORK, INC., 332 ACADEMY STREET, CARNEGIE, PA, 15106, US

(21) Appl. No.: 11/035,363

(22) Filed: Jan. 14, 2005

(51) Int. Cl. H01R 13/44

(52) U.S. Cl. 439/136

(57) ABSTRACT

An electrical plug and cord protection device for mounting to the wall and over a wall receptacle to prevent access to the receptacle and protect the plug and the cord that extends therefrom includes a dome-shaped cover portion hingably attached to a channel portion and a peripheral mounting flange through which screws are inserted for mounting the protective device to the wall. The cover portion can be pivoted away from the wall to allow selective access to the plug if the plug needs moved or the appliance needs unplugged. Additional channel extensions can be used to protect the cord if the cord extends a considerable length along the wall, and such channel sections can be straight or angled and are successively aligned and mounted to the wall as needed for covering and protecting the electrical cord.

### FIELD OF THE INVENTION

The present invention pertains to electrical protective coverings and safety devices, and more particularly pertains to a wall-mounted protective device for covering and protecting an electrical plug and electrical cord.

### BACKGROUND OF THE INVENTION

Among the many objects in a residential or business dwelling that pose a danger and hazard, especially to children and pets, are standard wall outlets and receptacles, and the electrical plugs and cord that are connected thereto. Such outlets or receptacles are located in every room of the dwelling, and generally placed at around 18 inches from the floor in accord with various state building codes and regulations. Because of their proximity, and also due to the natural curiosity and inquisitiveness of children and pets, the unprotected outlets become a danger and a hazard. Injuries and death result every year from inquisitive children sticking their fingers or any handy objects such as utensils and toys into the outlets.

Thus, covers and protective devices have been conceived to prevent this avoidable danger. A common protective device, referred to as a plug protector, includes a round base with two spaced—generally plastic—prongs protruding perpendicularly from one side of the base. The prongs are inserted into the two sockets of the electrical outlet and the base is disposed flush against the cover plate thus making it difficult for small children to pry this type of protective device from the outlet. However, this common type of protective device is for preventing access to the sockets of the receptacle and it makes the receptacle unusable for any electrical device or appliance as it is actually designed to impede the use of the receptacle. Thus, other types of protective devices have been conceived that permit the electrical plug to be plugged into the receptacle but which prevent access to and tampering with the plug and receptacle and which protect the electrical plug and cord. The prior art discloses the following examples.

The Wasserman patent (U.S. Pat. No. 3,955,870) discloses a utility outlet guard that is mounted to the cover plate and includes a hollow dome-shaped enclosure for protecting an electrical plug from accidental contact by children or pets.

The Pinkerton et al. patent (U.S. Pat. No. 4,718,856) discloses a safety cover for electrical outlets and includes a base plate, a dome-shaped shield and a flat shield fitted together for protecting and enclosing an electrical plug.

The Coffey patent (U.S. Pat. No. 5,306,176) discloses an electrical cord protector that includes a hollow cylindrical protector closed off by end caps so that a socket and plug assembly can be enclosed within and plugged to each other within the protector and with their respective cords extending outwardly through bores in the respective end plugs.

The Francis patent (U.S. Pat. No. 5,342,212) discloses an electrical protective device that includes a funnel-shaped member attached to a door having apertures so that the plug can be protected in the funnel-shaped member and the prongs of the plug can protrude through the door.

The Benson Jr. patent (U.S. Pat. No. 5,993,249) discloses an electric cord protector for preventing the electric cord of a hedge trimmer from being cut wherein the electric cord protector is in the form of an enlarged diameter cord.

The Moody patent (U.S. Pat. No. 6,050,834) discloses an electrical splash protector that includes shield portions that completely cover the prong openings and grounding pin opening of the electrical outlet.

The Cross et al. patent (U.S. Pat. No. 6,056,580) discloses an electrical cord and plug strain relief device that includes a retention device having sidewalls for receiving and holding therein a mating male plug and female socket and thereby preventing the separation of the plug and socket.

The Tardy patent (U.S. Pat. No. 6,250,946 B1) discloses an extension cord plug cover in the form a two half-clamshell covers that can be closed together and with each clamshell cover having cavities that mate with the cavities of the other clamshell cover for receiving and enclosing therein one or more extension cords and plugs.

Nonetheless, despite the ingenuity of the above devices, there remains a need for a plug and cord protector that easily mounts to the wall and provides access to the plug if desired while protecting the electrical cord and plug.

### SUMMARY OF THE INVENTION

The present invention comprehends an electrical plug and cord protection device for covering and protecting an electrical plug that is plugged into a wall receptacle and the length of electrical cord extending therefrom. The protective device is simple and easy to install over any wall outlet or receptacle for preventing serious injury and harm to curious and inquisitive children and pets by preventing tampering and access to the receptacle or the electrical cord plugged therein.

The electrical plug and cord protection device includes a dome-shaped cover portion hingably attached to a channel portion. The cover portion and channel portion define a continuous cavity for enclosing therein the electrical plug and a portion of the length of the cord that connects to the plug. A flange extends about the channel portion and the dome-shaped cover portion, and the flange has spaced screw apertures through which screws are inserted for mounting the protective device to the wall and over the wall outlet or receptacle. In addition, the protective device also includes straight and angled channel protector extensions that can be used to protect a considerable length of electrical cord that may run at various angles along the wall. The channel extensions would be mounted on the wall in a successive linear or non-linear manner in order to accommodate the extension of the electrical cord along the wall.

It is an objective of the present invention to provide an electrical plug and cord protection device that is a practical, easy to use, household safety device.

It is another objective of the present invention to provide an electrical plug and cord protection device that keeps all electrical cords and plugs protected, secured from tampering and off the ground.

It is yet another objective of the present invention to provide an electrical plug and cord protection device that sorts out and tidies up what would otherwise be a tangled mess of electrical cords and plugs at an electrical outlet.

It is still yet another objective of the present invention to provide an electrical plug and cord protection device that prevents small children and pets from gaining access to the electrical outlet thereby avoiding potentially serious injury or death from contact with the outlet.

Still yet another objective of the present invention is to provide an electrical plug and cord protection device that prevents the electrical cord from sagging onto the floor thereby making cleaning and vacuuming around the outlet easier and safer.

Yet another objective of the present invention is to provide an electrical plug and cord protection device that is transparent so that the homeowner can determine if the plug is damaged or becoming unplugged from the outlet with having to remove the protection device from its mounting on the wall.

Yet still another objective of the present invention is to provide an electrical plug and cord protection device that makes for a safer, less worrisome home environment.

A further objective of the present invention is to provide an electrical plug and cord protection device that provides access for the homeowner in order to unplug and move the electrical plug to another outlet without having to completely remove the protection device in order to gain access to the electrical plug.

A still further objective of the present invention is to provide an electrical plug and cord protection device that includes wall-mounted protector channel extensions interconnected to the protection device and successively aligned with each other for protecting an electrical cord that runs along a considerable length of the wall surface.

A still yet further objective of the present invention is to provide an electrical plug and cord protection device that is easy to install and mount with a minimum of tools and mechanical expertise.

These and other objects, features and advantages will become apparent to one skilled in the art upon a perusal of the following detailed description read in conjunction with the accompanying drawing figures.

### BRIEF DESCRIPTION OF THE DRAWINGS

FIG. 1 is a perspective view of the electrical plug and cord protection device of the present invention illustrating the mounting of the device to the wall and protecting and electrical plug and the outlet in which it is plugged;

FIG. 2 is a side elevational view of the electrical plug and cord protection device of the present invention taken along lines 2-2 of FIG. 1 illustrating the mounting of the device to the wall;

FIG. 3 is a side elevational view of the electrical plug and cord protection device of the present invention illustrating the hinged outlet cover opened to gain access to the electrical plug and electrical outlet;

FIG. 4 is a front elevational view of the electrical plug and cord protection device of the present invention illustrating the use of several channel extensions for protecting a considerable length of electrical cord extending along the wall to an electrical fixture such as a lamp; and

FIG. 5 is a front elevational view of the electrical plug and cord protection device of the present invention illustrating the use of several channel extensions, at least one of which provides for a 90 degree bend, for protecting a length of electrical cord extending in at least two directions on the wall.

### DETAILED DESCRIPTION OF THE PREFERRED EMBODIMENT

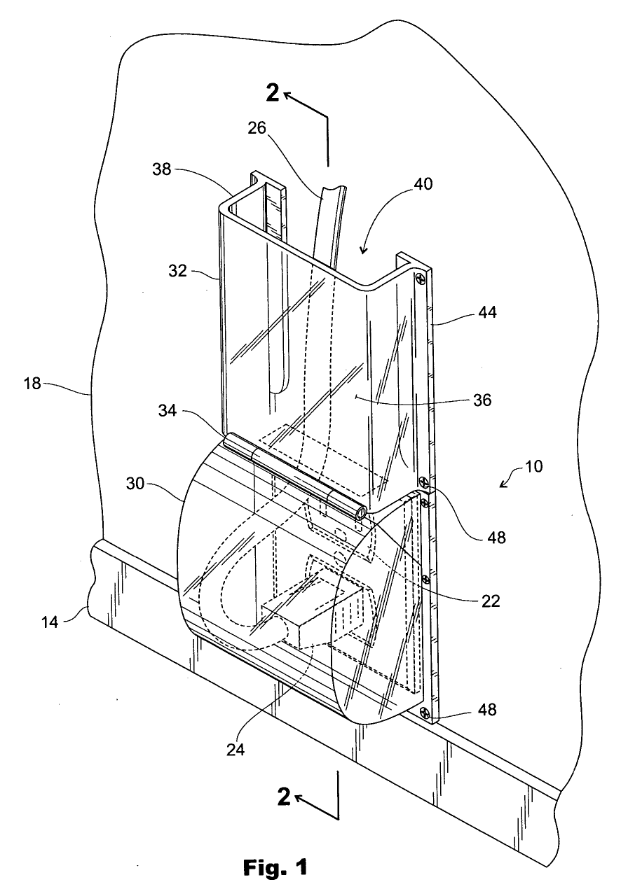

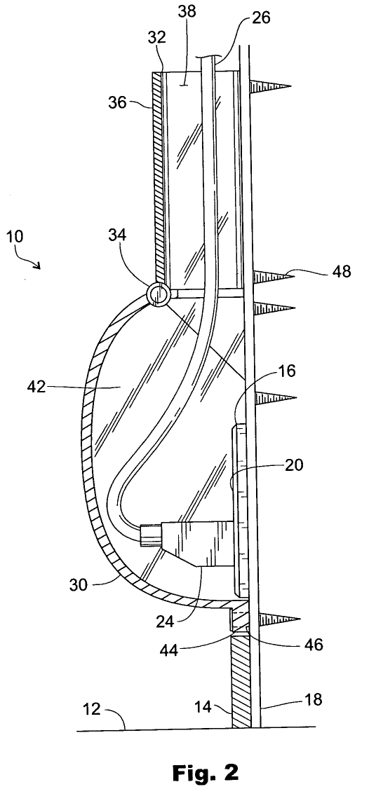

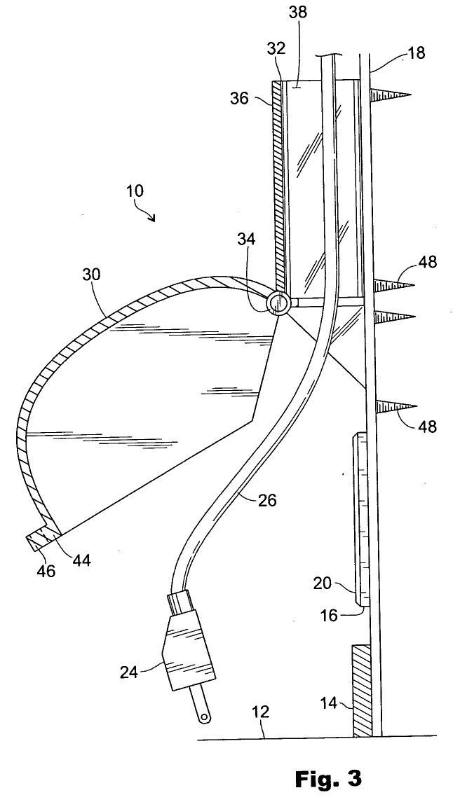

Illustrated in FIGS. 1-5 is an easy to install, relatively inexpensive electrical plug and cord protection device 10 for providing a safer home environment, especially for small children and pets. The device 10 of the present invention prevents tampering with electrical circuitry and wires, and protects against serious injury and even accidental death from occurring to inquisitive and curious children and pets. In addition, the protective device 10 cleans up a mess of electrical cords and wiring, and expedites cleaning and vacuuming by lifting such wiring up off the floor 12 and away from the baseboard 14.

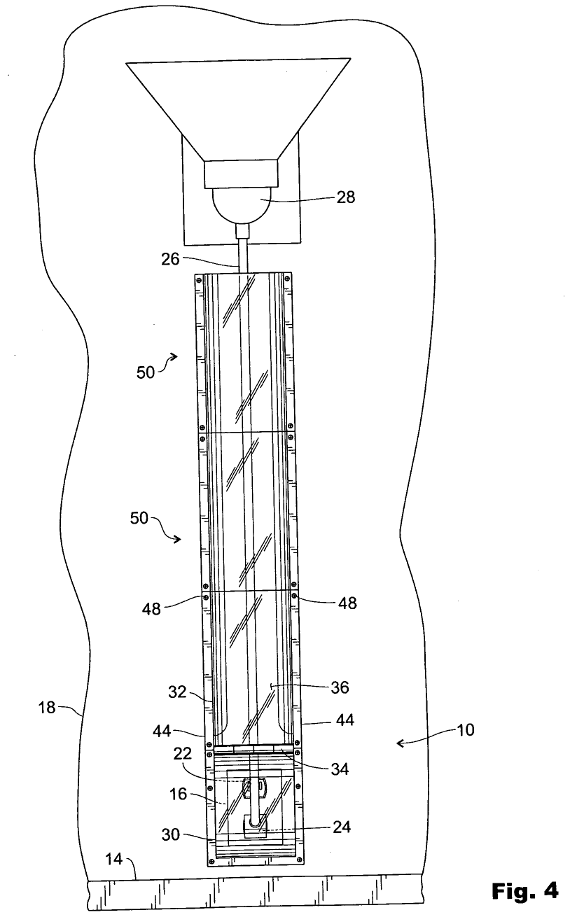

Thus, as shown in FIGS. 1-5, the electrical plug and cord protection device 10 is used for covering and protecting a standard wall outlet or receptacle 16 mounted to the wall 18 of a residential dwelling that exposes only the cover plate 20 and the electrical sockets 22 while covering the wiring running to the sockets 22. The protective device 10 completely covers the outlet 16 and the electrical plug 24 that is plugged into one or both of the sockets 22, and is also designed to cover at least a one-foot length of the electrical cord 26 attached thereto. The electrical cord 26 can extend from any number of electrical devices and appliances such as the wall-mounted lamp 28 shown in FIG. 4.

As illustrated in FIGS. 1-5, the electrical plug and cord protection device 10 is a two-piece assembly or unit manufactured from a lightweight, shatter-resistant, durable clear or white-colored plastic such as PVC. The electrical protection device 10 includes a dome-shaped outlet cover portion 30 that is generally sized to fit completely over and cover the standard cover plate 20 for the wall outlet 16. The dome-shaped outlet cover portion 30 is pivotally attached to a channel portion 32 by a hinge or swivel 34 so that the dome-shaped outlet cover portion 30 can be selectively swiveled or pivoted upward and away from the wall outlet 16 for allowing access, as desired, to the outlet 16 and the electrical plug 24.

The channel portion 32 includes a facing wall surface 36 and a pair of opposed sidewalls 38 integrally formed thereto and depending from the wall surface 36. The channel portion 32 preferably has a length of one foot, and the height of the sidewalls 38 should be at least one inch in order to provide sufficient clearance for allowing passage of the electrical cord 26 and plug 24 when the plug 24 is plugged into the wall outlet 16. The dome-shaped outlet cover portion 30 and the channel portion 32 both have the same width when mounted against the wall 18, but the concave configuration of the dome-shaped outlet cover portion 30 gives it a greater height than the channel portion 32. This concavity allows the dome-shaped outlet cover portion 30 to accommodate the initial bight in that portion of the electrical cord 26 that is adjacent the electrical plug 24. As shown in FIG. 1, the channel portion 32 includes an opening or mouth 40 that opens up opposite or away from the wall outlet 16 and the dome-shaped outlet cover portion 30. The channel portion 32 and the dome-shaped outlet cover portion 30 define a continuous inner cavity 42 that encompasses the electrical plug 24 and the electrical cord 26.

As shown in FIGS. 1-5, the electrical plug and cord protection device 10 includes a peripheral flange 44 that extends continuously about the channel portion 32 and the dome-shaped outlet cover portion 30. The flange 44 should preferably be at least ¼ of an inch thick, and when the electrical protection device 10 is mounted to the wall 18, the flange 44 is contiguous to the wall 18. As shown in FIGS. 1-3, spaced along the flange 44 are a plurality of screw apertures 46, and a fastener, such as a wood screw 48, is passed through each screw aperture 46 for mounting the electrical protection device 10 flush against the wall 18 and over the wall outlet 16 and electrical sockets 22. Should an individual desire access to the electrical plug 24, perhaps to unplug it and move the electrical plug 24 to another wall outlet, the individual would only have to remove the screws 48 in that portion of the flange 44 about the dome-shaped outlet cover portion 30, and then pivot the dome-shaped outlet cover portion 30 up and away from the wall 18 thereby exposing the wall outlet 16 and the electrical plug 24 that is plugged therein. After removing the electrical plug 24, the dome-shaped outlet cover portion 30 is pivoted down against the wall 18 so that the screws 48 can be reinserted through the apertures 46 thereby securing the dome-shaped outlet cover portion 30 to the wall 18. This pivotal feature of the electrical protection device 10 allows the individual to have access to the wall outlet 16 and electrical plug 24 without having to completely remove the electrical protection device 10 from the wall 18 and then remount it after the electrical plug 24 has been moved, for example, to another location.

The electrical plug and cord protection device 10 illustrated in FIG. 1 is the preferred embodiment of the invention. However, situations will arise where the electrical cord 26 will need to be extended a considerable length along the wall 18, and the extension may not be a linear extension from the electrical device 10 to the wall outlet 16 as shown in FIG. 4, but the extension may be at an angle or the path of the extension may involve, for example, bends around objects or pieces of furniture. Moreover, the electrical cord 26 may need covered and protected along its entire extension.

Thus, the electrical plug and cord protection device 10 includes straight channel protector extensions 50 that are of the same general configuration and dimensions as the channel portion 32. As shown in FIG. 4, the channel protector extensions 50 are mounted to the wall 18 in successive abutting—linear—alignment commencing or starting from the channel portion 32. The use of the channel protector extensions 50 as shown in FIG. 4 provides complete and full coverage and protection for the electrical cord 26 in its extension along the wall 18 from the wall outlet 16 to the wall-mounted lamp 28.

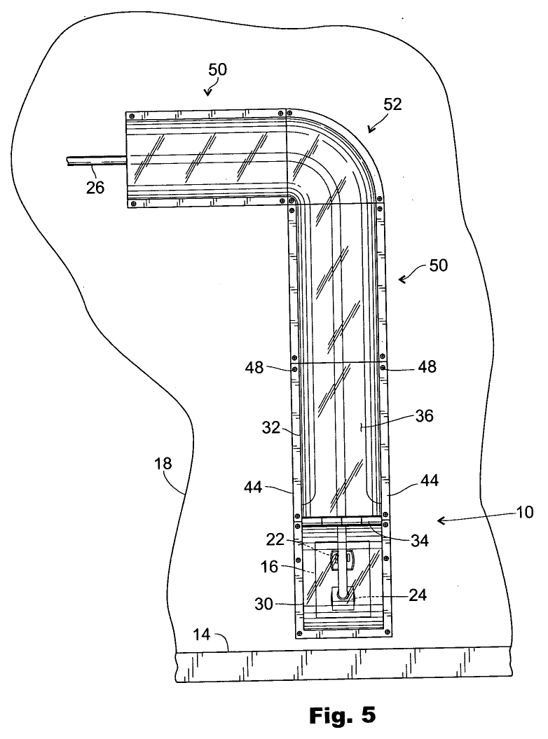

However, the channel protector extensions 50 can also include at least one extension that is of a non-linear or angled configuration such as the 90-degree L-shaped channel extension 52 shown in FIG. 5. This L-shaped channel extension 52 would be used to cover the electrical cord 26, and allow the electrical cord 26 to make a bend—as illustrated in FIG. 5, a 90 degree bend—while extending along the wall 18 from the electrical device 28 to the wall outlet 16. The use of the channel extensions 50 and 52 allows the individual to direct the extension of the electrical cord 26—vertically, horizontally or at angles therebetween—while protecting and covering the full extension of the electrical cord 26. The channel extensions 50 and 52 thus provide for greater flexibility and adaptability in the use of the electrical protection device 10.

While the invention has been shown and described in a preferred embodiment, it will be apparent to those skilled in the art that numerous modifications, alterations and variations will be possible and practicable without departing from the spirit of the invention of the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An electrical plug and cord protection device for covering and protecting a wall receptacle, an electrical plug and an electrical cord that extends from the electrical plug along a wall, comprising:
a two-piece assembly mountable to the wall for covering the wall receptacle, the two-piece assembly including a dome-shaped outlet cover portion pivotally attached to a channel portion;
an interior wall interconnecting the dome-shaped outlet cover portion to the channel portion;
the interior wall including an aperture through which the electrical cord can extend;
the channel portion being in registration with the dome-shaped outlet cover portion so that the electrical cord is covered by the outlet cover portion and enclosed within the channel portion thereby directing the electrical plug away from the wall receptacle when the electrical plug is plugged into the wall outlet;
a plurality of channel protector extensions with each channel protector extension having a pair of opposed channel flanges that are disposed against the wall and are securable thereto and whereupon the channel protector extensions can be successively abutted one against another commencing from the channel portion for covering and protecting the length of electrical cord that extended from the electrical plug and along the wall; and
wherein at least one channel protector extension has an l-shaped configuration to allow that channel protector extension to make a 90 degree bend along the wall concomitant with covering and protecting the length of electrical cord.

22. An electrical plug and cord protection device for covering and protecting a wall receptacle, an electrical plug, and an electrical cord that extends from the electrical plug along a wall, comprising:
a two-piece assembly mountable to the wall for covering the wall receptacle, the two-piece assembly including a dome-shaped outlet cover portion pivotally attached to channel portion;
a plurality of channel protector extensions with each channel protector extension having a pair of opposed channel flanges that are disposed against the wall and are securable thereto and whereupon the channel protector extensions can be successively abutted one against another commencing from the channel portion for covering and protecting the length of electrical cord that extends from the electrical plug and along the wall; and
wherein at least one channel protector extension has an l-shaped configuration to allow that channel protector extension to make a 90 degree bend along the wall concomitant with the extension of the length of electrical cord for covering and protecting the length of electrical cord.
